(19) United States
(12) Patent Application Publication
(10) Pub. No.: US 2023/0263154 A1
(43) Pub. Date: Aug. 24, 2023

(54) WATERFOWL DECOY MACHINE

(71) Applicant: Huntwise, Inc., Monroe, LA (US)

(72) Inventors: Terry DENMON, Monroe, LA (US); Chartes L. SMART, Monroe, LA (US)

(73) Assignee: Huntwise, Inc., Monroe, LA (US)

(21) Appl. No.: 18/112,945

(22) Filed: Feb. 22, 2023

Related U.S. Application Data
(60) Provisional application No. 63/312,969, filed on Feb. 23, 2022.
(60) Provisional application No. 63/393,113, filed on Jul. 28, 2022.

(51) Int. Cl. A01M 31/06

(52) U.S. Cl. CPC A01M 31/06

(57) ABSTRACT

An at least partially buoyant decoy apparatus for use in the water is provided that mimics the look of a diving or feeding animal. The decoy comprises in various embodiments an exterior shaped at least partially in the shape of an animal, a propeller, a power source, and a motor, wherein the propeller and a power source are operationally coupled to a motor such that the powered motor is capable of acting on the propeller to create a downward thrust relative to the water line of the body of water in which the decoy resides to make the decoy apparatus move dip or dive into the water for a period of time, to be released back to the surface when the motor ceases to act on the propeller.

### CROSS-REFERENCE TO RELATED APPLICATIONS

This application claims priority to U.S. provisional patent application Ser. No. 63/312,969, also entitled “Waterfowl Decoy Machine,” which was filed on Feb. 23, 2022, and U.S. provisional patent application Ser. No. 63/393,113, also entitled “Waterfowl Decoy Machine,” which was filed on Jul. 28, 2022.

### STATEMENT REGARDING FEDERALLY SPONSORED RESEARCH OR DEVELOPMENT

Not Applicable.

### FIELD OF THE INVENTION

This invention relates to a decoy device that creates life-like movement. More particularly, the invention relates to a buoyant decoy device with a motor that actuates a propeller that causes the decoy to bob and move within the water to mimic a live waterfowl.

### BACKGROUND INFORMATION

Outdoor enthusiasts, recreational hunters, and photographers have long recognized that live animals and game, and particularly live waterfowl, are attracted to areas that appear to be inhabited by similar animals. For this reason, hunters have used decoys to attract live game to within shooting distance of a hunter's rifle, shotgun or other weapon, and within prime viewing distance of photographers and other outdoor enthusiasts.

In order to be effective, a decoy must resemble the animal. In theory, the more life-like a decoy looks, the more likely that the intended animal will be fooled by the decoy into behaving as intended. For example, numerous hunters place duck decoys at or near the surface of the water to signal to other ducks to approach the area. A large industry has formed around the creation and selling of these types of decoys.

Traditional decoys are motionless molds resembling at least a portion of an animal. For waterfowl decoys, these decoys typically comprise partially buoyant structures shaped into the look of a body and head of the waterfowl and float along the water's surface. Although the decoys may have resembled an animal, their rigid nature limited their functionality. To overcome this limitation, technology was employed to make the decoys more life-like by adding motion.

Perhaps the most prevalent motion decoy is a spinning wing decoy designed to give the appearance of a waterfowl flapping its wings. When placed near the water, the decoy gives the illusion that a waterfowl is landing in an area, giving the look that the area is safe for ducks to land. While these decoys have enjoyed and continue to enjoy great success, room remains for further innovation to supplement or even replace traditional stationery and motion decoys.

A decoy device is provided herein which aims to mimic the natural appearance of an animal feeding in water through a simple and user-friendly mechanism, thereby rendering the device more efficient, less costly to manufacture, and more robust against breakage. As described herein, the device uses a propeller to cause a floating decoy body to bob and move in the water, which in some embodiments is operated for varied intervals of time. The floating, bobbing (or bouncing), and movement caused by the configuration of the device mimic the look of a live waterfowl diving after food in the water. Preferably, the decoy body extending above the water resembles the tail end of a waterfowl. All of the components are specifically designed to be waterproof, whether intrinsically or through the use of waterproof housing.

### BRIEF DESCRIPTION OF THE DRAWINGS

The drawings constitute a part of this specification and include exemplary embodiments of the WATERFOWL DECOY MACHINE, which may be embodied in various forms. It is to be understood that in some instances, various aspects of the invention may be shown exaggerated or enlarged to facilitate an understanding of the invention. Therefore, the drawings may not be to scale.

FIG. 1(a) is a prospective view of an assembled decoy according to one embodiment of the instant invention.

FIG. 1(b) shows a turned view of the decoy in FIG. 1A.

FIG. 1(c) shows a bottom-up view of the decoy in FIG. 1A.

FIG. 1(d) shows a top-down view of the decoy in FIG. 1A.

FIG. 2 shows various views of the decoy portion of the decoy in FIG. 1 wherein the decoy portion is removed from the buoy portion for ease of reference.

FIG. 2(a) is a side view of the decoy portion.

FIG. 2(b) is a turned view of the decoy portion.

FIG. 2(c) is a bottom up-view of the decoy portion showing a hollow center and slide connectors.

FIG. 3 shows various views of the buoy portion of the decoy.

FIG. 3(a) depicts a perspective view of the buoy portion with the inner housing removed.

FIG. 3(b) depicts a side view of the buoy portion.

FIG. 3(c) depicts a downward view into the cavity of the buoy portion showing a mounting plate for the interior housing.

FIG. 3(d) shows a lid to close the top of the buoy portion.

FIG. 4 is a cross sectional view of the decoy portion showing the cavities of the inner housing and location of the battery cavity, activation switch, and USB charging device.

FIG. 5 presents various views of the inner housing and cavities of FIG. 4.

FIG. 5(a) is a perspective view of one embodiment of an interior housing member.

FIG. 5(b) shows the battery housing and power switch.

FIG. 5(c) shows the same embodiment of the battery housing with the wires connected to nodes.

FIG. 5(d) shows an alternate embodiment of a housing with cavities for a battery, an electrical outlet, an on/off switch, and a transceiver.

FIG. 5(e) shows a bottom-up diagram of the embodiment in FIG. 5(d).

FIG. 6 shows the components of one embodiment of a guard.

FIG. 7 shows various views of a motor housing.

FIG. 7(a) shows a perspective view of a motor housing.

FIG. 7(b) shows a side view of a motor housing.

FIG. 7(c) shows a bottom-up view of a motor housing.

FIG. 8 shows representations of a motor.

FIG. 8(a) shows a perspective view of a motor including a motor shaft and a motor mount.

FIG. 8(b) shoes shows the same motor showing a cross section of the motor shaft.

FIG. 9 is an exploded view of the buoy portion without the lid, but including the motor, propeller, and connector arms.

FIG. 10 shows a perspective view of another embodiment of the decoy with a guard surrounding the propellor, wherein the propeller is positioned beneath the motor.

FIG. 11(a) shows alternate views of the embodiment in FIG. 10 showing a sliding lock connection means.

FIG. 11(b) shows a turned view of the decoy in FIG. 11(a).

FIG. 12(a) shows a perspective view of the battery housing.

FIG. 12(b) shows a top-down view of the battery housing.

FIG. 13 shows various views of the module box of the decoy in FIG. 10.

FIG. 13(a) is a perspective view of the module box.

FIG. 13(b) is a side view of the module box.

FIG. 13(c) is another side view of the module box to show the positioning of the support arms.

FIG. 13(d) is a top-down view of the module box.

FIG. 14 shows various views of the motor positioned in FIG. 13(d).

FIG. 14(a) is a perspective view of the motor showing the slide locking mechanisms.

FIG. 14(b) is a top-down view of the motor showing the motor shaft and the slide lock mechanism.

FIG. 14(c) is a sideview of the motor.

FIG. 15 shows various angles of one embodiment of a propeller guard.

FIG. 15(a) is a bottom-up view of the guard attached to the decoy.

FIG. 15(b) is a perspective view showing the interior of the guard removed from the decoy.

FIG. 15(c) is a side view of the guard removed from the decoy.

FIG. 15(d) is a bottom-up view of the guard removed from the decoy body.

FIG. 16(a) shows a side view of a guard with additional guard walls.

FIG. 16(b) is a perspective view of the guard in FIG. 16(a).

FIG. 17 shows various views of the slide lock connectors which attach the decoy portion to the buoy or module box.

FIG. 18 presents various connection means.

FIG. 18(a) presents an exterior and corresponding cross section view of a decoy buoy using a threaded screw top.

FIG. 18(b) presents an exterior and corresponding cross section view demonstrating a hinged connection means with a watertight groove.

FIG. 18(c) presents an exterior and cross section view of one embodiment of a decoy using a slide lock.

FIG. 18(d) presents additional detail of the depicted slide lock connectors.

FIGS. 19(a)-19(d) presents various views of a propeller that may be used in connection with a decoy unit.

FIG. 20 shows an example of a propellor nut for connecting the propeller.

FIG. 21(a) presents an alternative embodiment of a module box housing with fins for directing the flow of water.

FIG. 21(b) is a side view of the embodiment in FIG. 21(a).

### DETAILED DESCRIPTION OF THE INVENTION

The subject matter of the present invention is described with specificity herein to meet statutory requirements. However, the description itself is not intended to necessarily limit the scope of claims. Rather, the claimed subject matter might be embodied in other ways to include different components or combinations of components similar to the ones described in this document, in conjunction with other present or future technologies.

Described herein is a novel waterfowl decoy that mimics the motion of a live waterfowl diving in the water to feed. The decoy may be at least partially shaped like a portion of a waterfowl. For example, the decoy portion may be shaped like the tail end of a waterfowl. The decoy may be buoyant such that it is capable of floating. The decoy may be configured such that the portion of the decoy which rests above the water line resembles the shape of at least a portion of an animal, preferably a waterfowl. In a preferred embodiment, the decoy may be self-righting in the water.

This invention mimics the natural movement or activity of game, particularly a waterfowl or group of waterfowl. The invention in particular mimics a waterfowl feeding and creates ripples on the water surface in connection with the bobbing and/or bouncing motion of the decoy to attract other waterfowl. Likewise, in one or more embodiments, the decoy may dive into the water wherein it may contact and disturb the mud on the bottom of the body of water similar to action made by live waterfowl.

The decoy apparatus may comprise a propeller actuated by a motor energized by a power source. This power source may be an onboard battery or may be an external power source (be it a battery connected by cable or otherwise). In one or more embodiments, the motor actuates the propellor in timed cycles ranging from fractions of a second to several seconds. The motor may be controlled by a cycler which is a chip programmed to turn on and off the motor in cycles. The cycles may be random, or they may be pre-programmed time intervals. When the propeller is actuated by the motor, the propeller will rotate causing a driving force that propels the decoy deeper into the water. This downward motion may then be counteracted by the buoyant force of the decoy, preventing it from sinking. The counteracting force may create motion. Notably, the counteracting forces of the propeller and the buoyancy may cause the decoy to bob up and down in relation to the water line, mimicking a live animal feeding. The decoy may comprise an anchor or other device to maintain the decoy's relative location in the body of water.

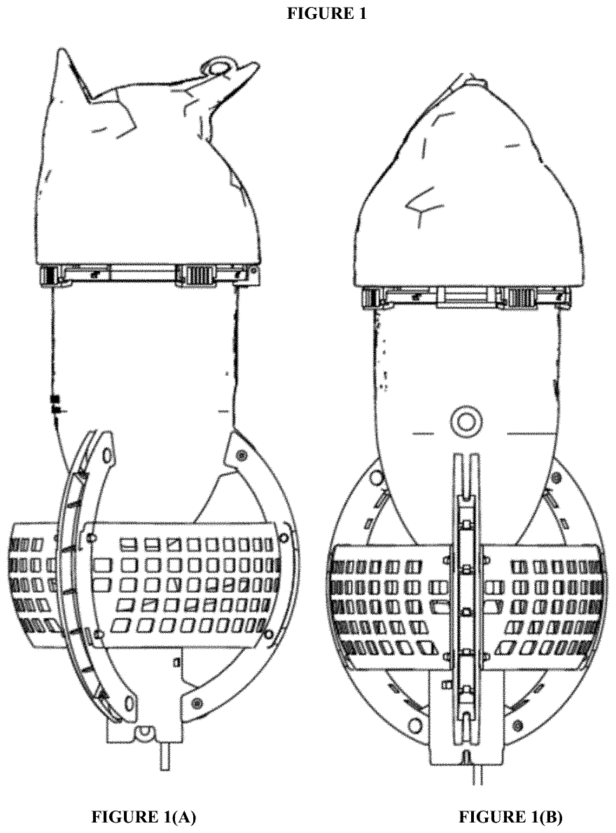

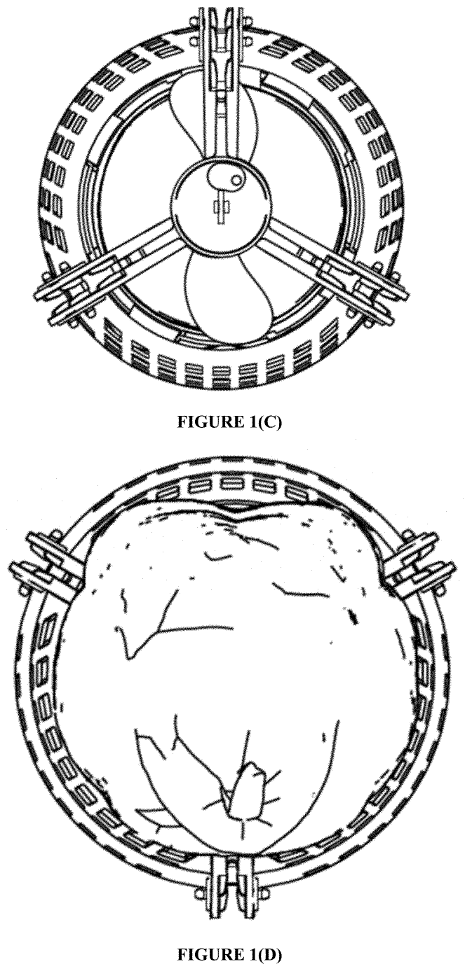

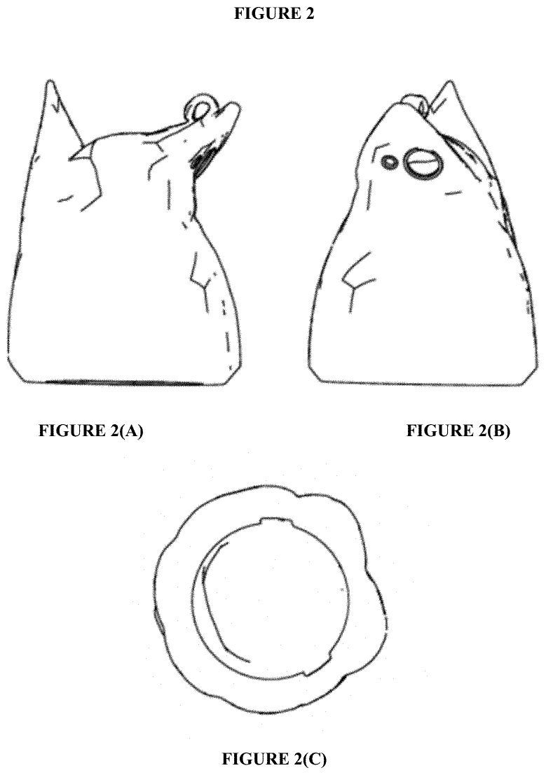

Turning to FIGS. 1A, 1B, 2 and 3, an embodiment of the device is shown that comprises a decoy portion 1 and a buoy portion 2. The decoy portion 1 is preferably shaped like the body of a waterfowl. The decoy portion 1 may vary in size to appear more lifelike. Additionally, the decoy portion 1 may be interchangeable. In an exemplary embodiment, as shown in FIG. 2, the decoy portion 1 is in the shape of the tail end (or butt) of waterfowl to give the appearance of a waterfowl dipping its head below the water to feed. The decoy portion may, in alternate embodiments, comprise different parts of an animal's body. For example, it may comprise a butt, wings, body, head, feet, neck, or any combination of the foregoing. In a preferred embodiment, the decoy portion 1 comprises a tether loop or handle 1d to which a rope/tether can be attached. The decoy portion may further comprise a charge or power inlet 1b and/or an on/off switch 1c.

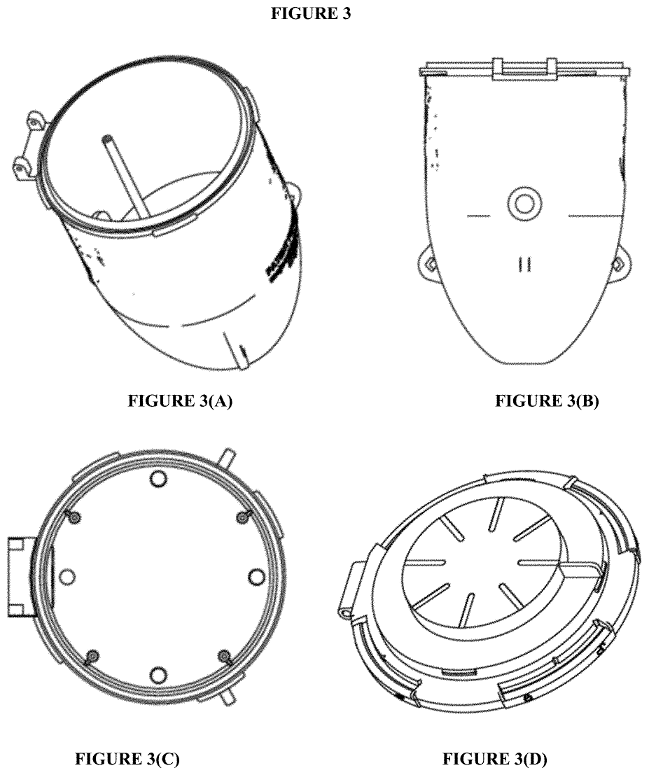

The buoy portion 2 may comprise a housing structure that is capable of housing the various electronic components of the system. In a preferred embodiment, the buoy is buoyant. The buoy portion 2 may be separate from the decoy portion 1 or may be conjoined into one unit. In other embodiments, the buoy portion 2 may be couplable to the decoy portion 1. For illustrative purposes, the buoy portion 2 is discussed herein as separable from the decoy portion 1, with decoy portion 1 forming a top to buoy portion 2, shielding the contents from the environment when coupled. The buoy portion 2 may further comprise a lid (such as the lid depicted in FIG. 3(d)) to close the buoy portion at least substantially. Such lid may form a waterproof or semi-waterproof seal to present water from entering the buoy cavity. In one or more embodiments, the decoy portion may connect with a connection means on the lid, such as a ridge or slide lock, to couple to the buoy portion. The lid may also be connected through other connection means such as threaded connections, snap connections, slide connections, friction fit connections, slide-lock connections, hinge connections, and combinations thereof. The lid may also be used in connection with a gasket or other waterproofing means such as a ridge and channel 24a.

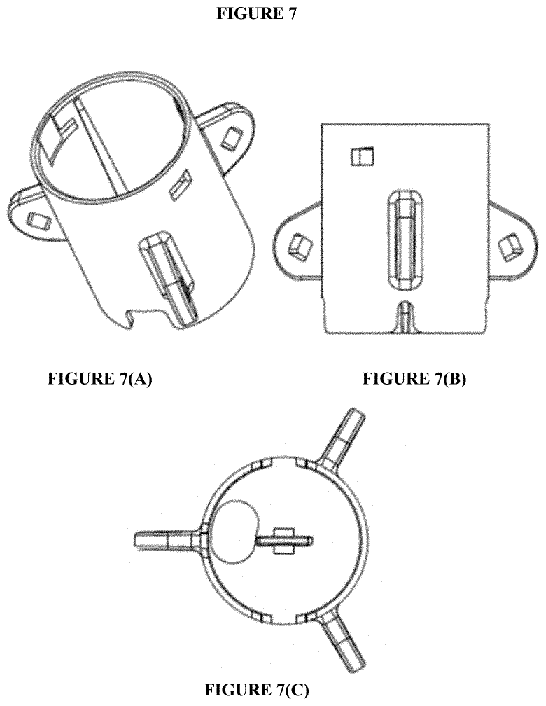

As shown in FIGS. 1, 3-9, the buoy portion 2 comprises an outer buoy 3, one or more connecting arms 5a, and a propeller 4 in communication with a motor 19 within a motor housing 6. The connection arms 5a, 5b connect the motor 19 and propeller 4 to the outer buoy 3. As depicted, motor housing 6 comprises legs 17′ to which the arms may connect. Such legs may comprise brackets. The connection arms 5a may be made of any lightweight water-resistant material and can be used for transporting and handling the decoy. In one or more embodiments, there may only be one connection arm or two connection arms. In other embodiments, a protective guard 23 may be connected to the connection arms 5a, 5b, 5c to surround the propellor 4 without impeding the propellor's motion. In other embodiments still, the motor 19 and propeller 4 may be connected to the outer buoy 3 without the use of the arms, such as with a single shaft through the motor and propeller to the outer buoy 3 interior. In a preferred embodiment, the connection arms and the protective guard are configured and located in a manner such that they do not substantially interfere with the propulsion generated by the propellor. The motor may comprise motor mount 19b. The motor may be mounted via one or more plates, motor mounts, brackets, motor hubs, slide locks, set screws or other means known in the art.

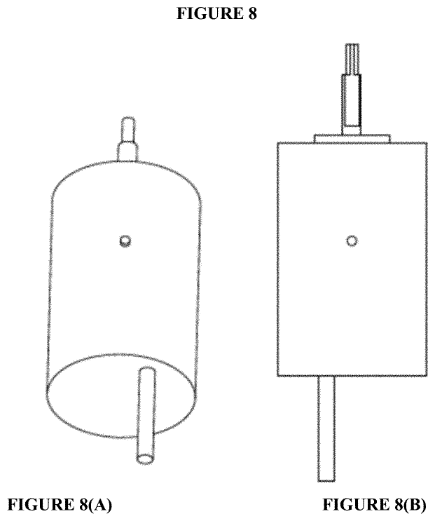

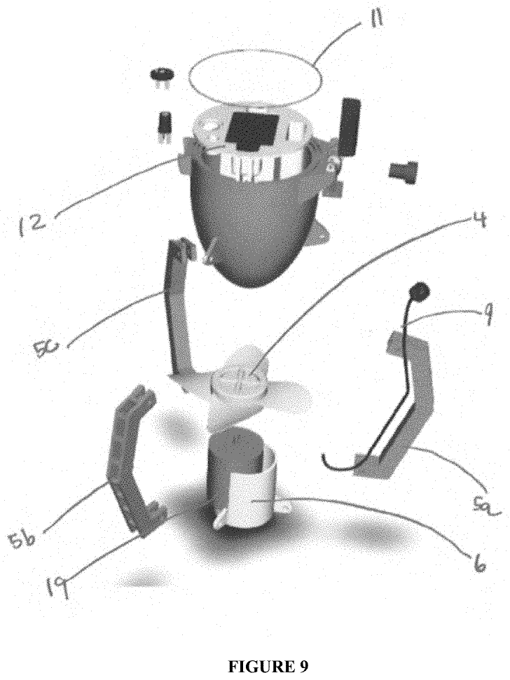

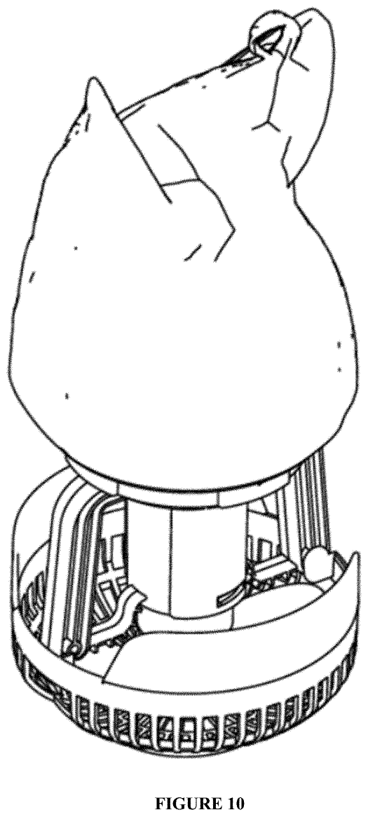

FIGS. 1A, 1B, 4 and 9 further depict a power cord 9 and power inlet 11. As shown, the power cord 9 may be fed through one of the arms 5a through an arm channel 10. FIG. 8 depicts the motor 19. Any motor as known in the art suitable for this application may be used. The power cord is used to operationally connect the motor 19 to the battery 15. In the depicted embodiment, the power cord 9 is fed through an arm channel 10 and passes through the outer buoy 3. In this embodiment, it is preferable that the connection point between the motor 19 and the power cord 9 and the outer buoy 3 and the power cord 9 be watertight. In the depicted embodiment, an inlet screw 20 is used at the power inlet 11 to create a watertight seal. One embodiment of the watertight intel screw 20 and power inlet 11 is shown at FIG. 9. However, other means are contemplated.

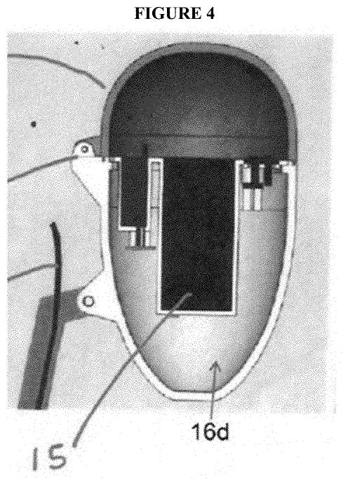

FIG. 3(d) shows lid 14. FIG. 4 shows an alternative lid depicted as domed top 14a. In some embodiments, the decoy portion 1 may comprise solely of the domed top 14 without a decoy body. In alternative embodiments, the lid 14 or the domed top 14 may serve as a connection point for a decoy portion 1. In one or more embodiments, the decoy portion 1 may be connected to the buoy portion 2 with a hinge 13. In other embodiments, the decoy portion 1 may be connected to the buoy portion 2 with a clip or hinge 8. In alternate embodiments, the connector may be a hinge or other known connection means. The dome top may be replaced with a top that is shaped like at least a portion of an animal.

As shown in FIGS. 3(d) and 2(c), lid 14 may have decoy connection ridges 14(b) and the decoy body may comprise connector ports 1(a). These components may be operationally configured to align such that the ridge can pass into the port, at which time the user can twist the decoy body to secure the components together. Alternate connection means are also envisioned.

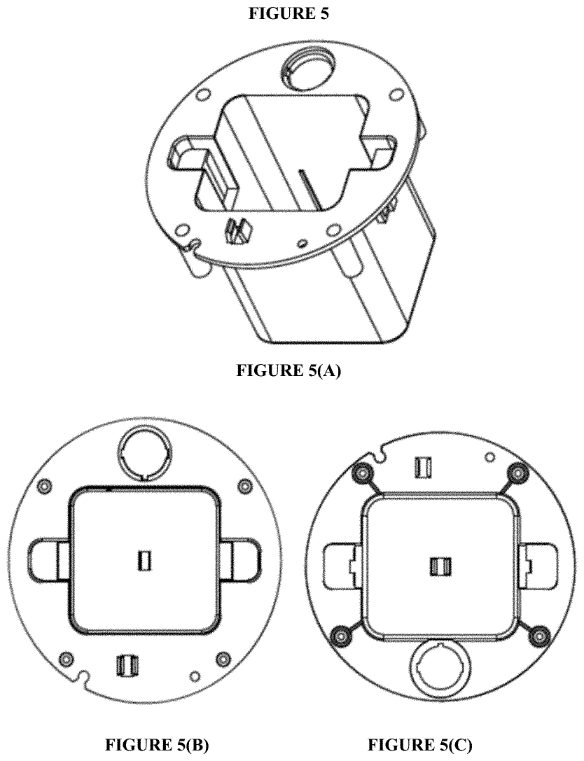

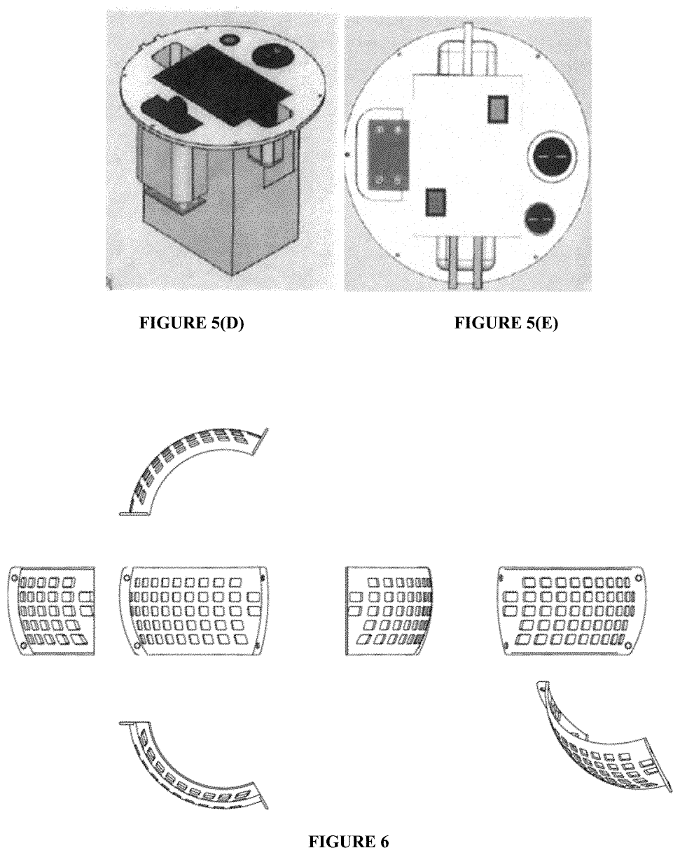

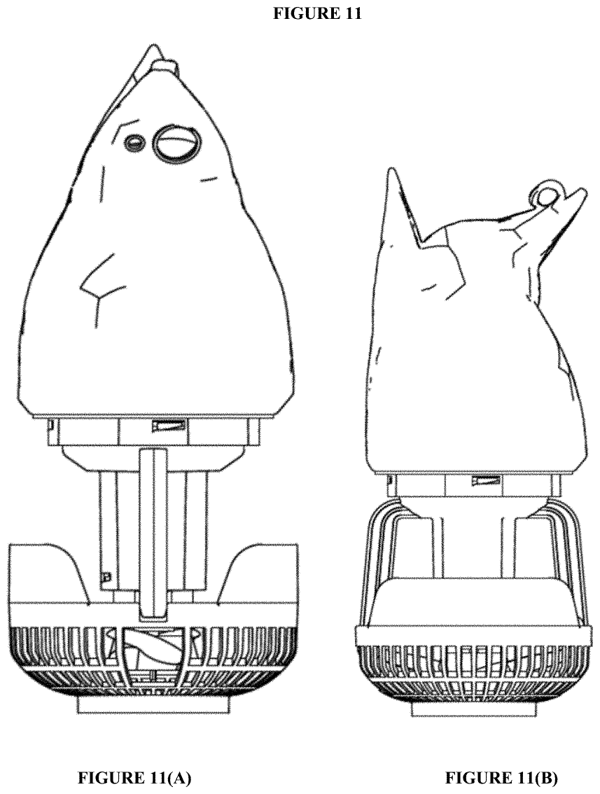

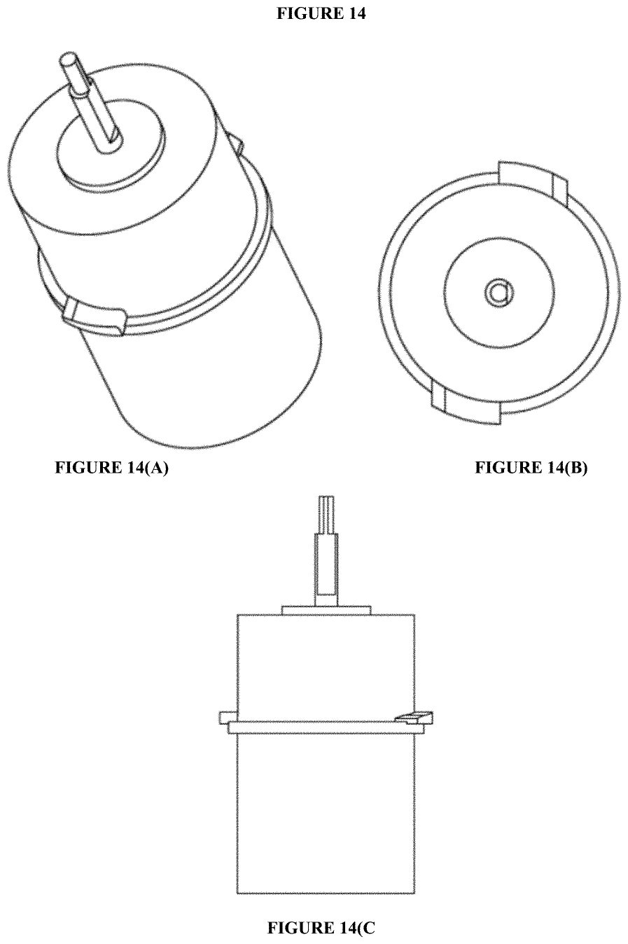

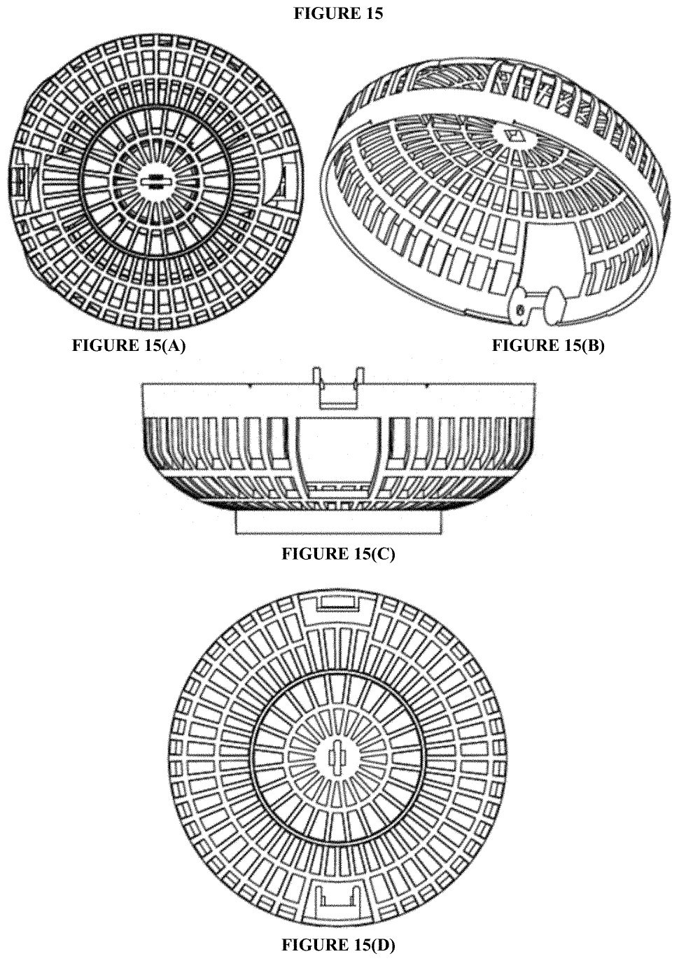

As shown in FIGS. 4, 5, and 9, the outer buoy 3 comprises an inner housing 12. The inner housing may refer to the general interior space defined by the walls of the outer buoy. The inner housing may comprise supporting structures, mounting brackets, platform cavities, and other mechanisms to secure the various electronics and other components housed within the outer buoy. As depicted, the inner housing 12 may comprise one or more cavities 16a, 16b, 16c, and 16d. As shown, cavity 16a may be shaped to accommodate a battery 15, cavity 16b may be shaped to accommodate a motor activation switch, and cavity 16c may be shaped to accommodate a charging or connecting device, such as a receiver or power cord. It is understood that any number of cavities may be used in various configurations, or no cavities may be used at all. For example, the modular design depicted in FIGS. 11-14 may only have cavities for the battery 115 and/or the motor 119. Turning back to FIG. 5(d), the cavity 16c may accept a transmitter such that the motor 19 can be remotely actuated. Power may be provided to this cavity in ways known in the art and as determined by the transmitter selected. This transmitter may be Bluetooth or a simple on-off transmitter such as an FCC, RC, or RF transmitter. The transmitter may also be pairable with a cellular device. The transmitter may be stored or storable within a cavity while not in operation. The charging means may be USB, 3-pin, A/C plug, D/C plug or other means known in the art. Likewise, the remote transmitter may be connected via USB, 3-pin or means known in the art. 16d is the cavity below these components. In one or more embodiments, cavity 16d may be foam filled to aid in buoyancy.

The inner housing 12 may also comprise slits or slots 21 around the battery cavity 16a in order to facilitate easy removal and replacement of the battery 15. In one or more embodiments, the cavities may be situated such that the motor activation switch is facing on the outside of the outer buoy 3 so that a user can access the switch when a decoy body is already in place. In this case, the activation switch is preferably watertight. In other embodiments, such as the embodiment shown in FIG. 2(b), the on/off switch may be located in the decoy portion 1. In another embodiment, a power port may be located in either the buoy portion 2 or the decoy portion 1. In such an embodiment, one or more wires may be run into the decoy body. A tether may also be used to maintain the decoy portion in proximity to the buoy or module portion. Preferably, when the on/off switch is located in the decoy portion 1, the tether will have a length that is less than that of the wire run to the switch to prevent disconnection.

As shown in FIG. 3(a)-3(c), the outer buoy 3 is a semi-ellipsoidal structure with a hollow interior capable of receiving the inner housing 12. Other shapes are contemplated, such as a half sphere or cylinder. In one or more embodiments, the outer buoy 3 is made of buoyant material. In one or more embodiments, the outer buoy 3 cavity is filled with buoyant material such as foam to provide added buoyance and to contribute to more chaotic, i.e. —lifelike movement of the In another preferred embodiment, the buoy is operationally configured to be self-righting in the water. The outer buoy 3 may be made of plastic, molded plastic, resin, metal, wood, or other durable material. In a preferred embodiment, the outer buoy may be made of molded plastic. In alternate embodiments, there is no elliptical outer buoy structure and instead the decoy unit as a whole is buoyant. Such an embodiment is depicted in FIGS. 10 and 11.

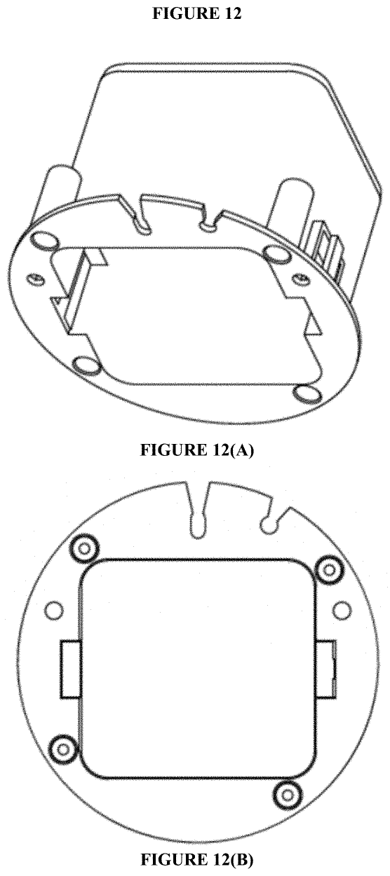

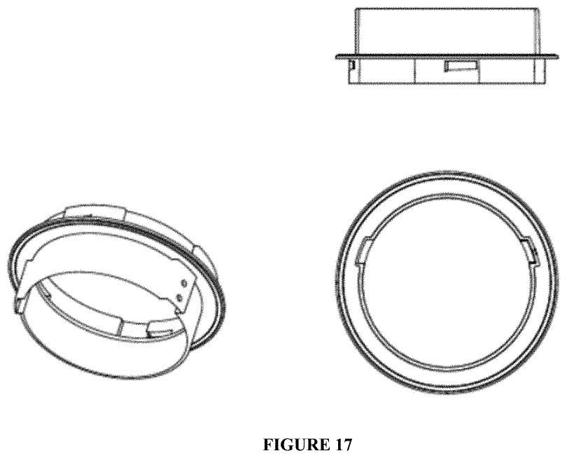

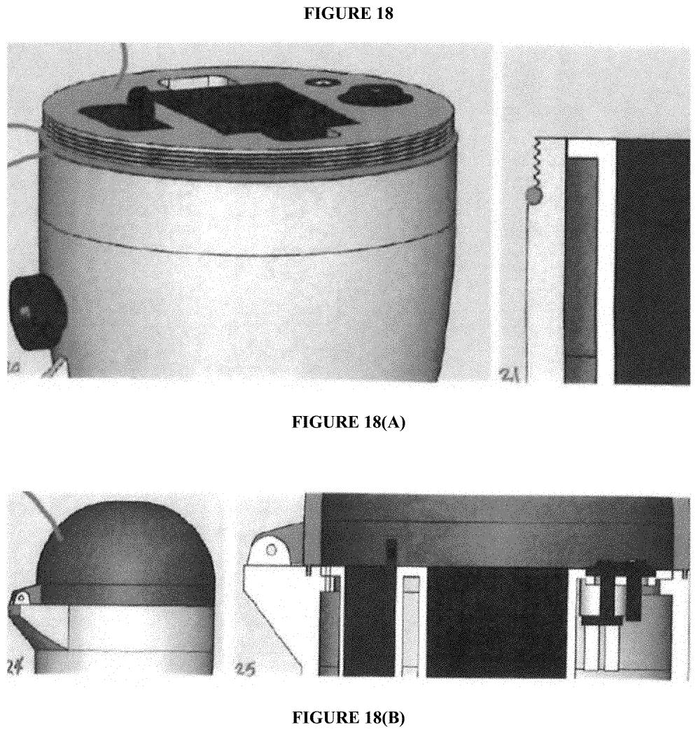

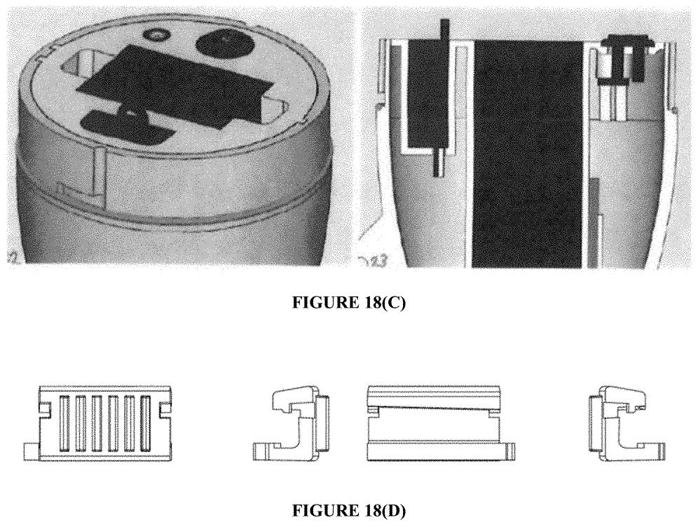

The outer buoy 3 may couple with the decoy portion 1 and separately with the legs 17. The legs 17 comprise a connector piece extended from the outer buoy 3 to which one or more arms 5 may be mounted. The arms 5 may be mounted on the opposing end to lower legs 17′. In one or more embodiments, the outer buoy 3 may couple with the decoy portion 1 via a hinge 18 such as the embodiment in FIG. 18(b). It is preferred that all electronics within the inner housing be shielded from the environment and, particularly, from water. The housing may be waterproof or at least water resistant. As such, the connection between the outer buoy and the decoy portion may be water resistant, waterproof, or watertight. In other embodiments, additional internal waterproof or water-resistant means may be employed internally in the interior housing, such as by using a lid 14. The decoy portion may be connectable to the outer buoy via a sliding lock mechanism such as those shown in FIGS. 17 and 18. It may also be connectable directly to the lid 14 as previously discussed. It may also be connected via threading connections, snap connections, slide connections, friction fit connections, slide-lock connections, hinges, and combinations thereof. Such connections may be used in conjunction with a gasket. They may also be used in connection with an O-ring or groove system to act as a water barrier. As shown in FIG. 18, the watertight sealing mechanism may comprise a threaded screw connection 22 with a gasket 24. In one or more embodiments, the top portion (i.e., the decoy portion) may be threadedly connected to the bottom (or buoy portion). In other embodiments, the watertight sealing mechanism comprises a twist lock, such as the embodiment in 18(c). In other embodiments still, the watertight sealing mechanism may comprise any combination of these mechanisms or other watertight sealing mechanisms known in the art. As shown in FIGS. 12, 18(c), and 18(d), a slide connection 122 with locking ports or slide lock members 122a and slot catch 122b may be employed. In one or more embodiments, the decoy portion may be tethered to the buoy portion to keep the components in proximity when not securely connected.

FIG. 9 depicts an exploded view of the buoy portion 2. As shown, propeller 4 may be coupled to the motor 19 through motor shaft 19a. When the motor is activated, the motor will rotate the motor shaft, causing the propeller to spin. In one or more embodiments, the propeller 4 is sized so that it is small enough to minimize added weight to the decoy while still providing enough energy to cause the decoy to move and bob. The propeller may be selected based on the motor rotational speed, the pitch, the blade angle, or the number of propellers, or a combination of one or more of the foregoing. The propeller and motor may be selected or configured to propel the decoy into the water column. In one or more embodiments, the movement by the propeller may cause the decoy to at least partially be submerged or fully submerged.

The motor 19 may have a rate of spin by which the motor causes the motor shaft to spin. Thus, the motor may have a rate of spin by which the motor causes the propeller to spin about an axis. The motor rate, measured in rotations per minute (rpm), may be between 1-500 rpm, between 1-350 rpm, between 1-250 rpm, between 1-200 rpm, between 1-150 rpm, between 1-100 rpm, 1-50 rpm, between 1-25 rpm, between 1-10 rpm, between 10-100 rpm, between 10-75 rpm, between 10-50 rpm, or between 10-25 rpm. In various embodiments, the motor may have a variable rate of spin. The motor may be capable of being set to various rpm by the user, or the motor may be engaged in cycles of varying rpm.

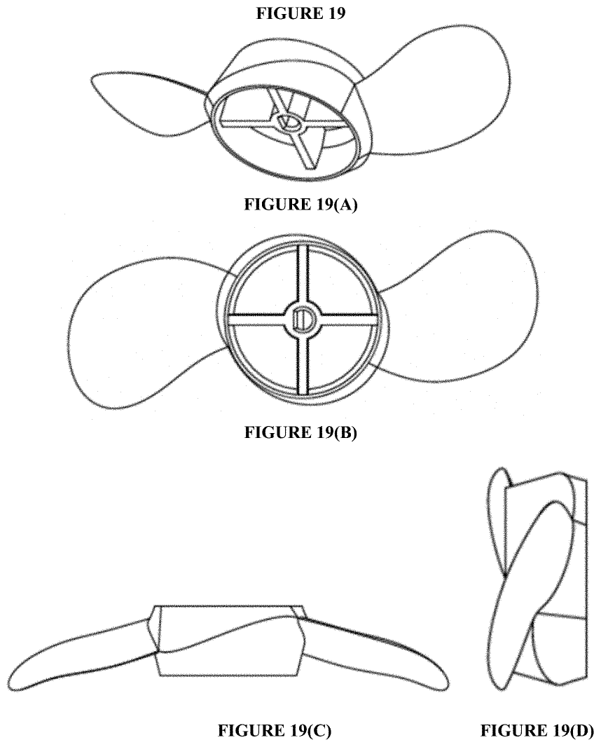

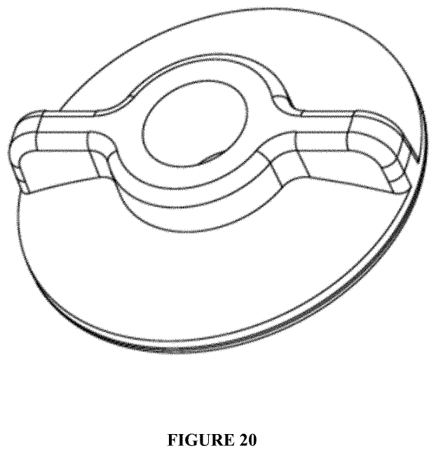

FIG. 19 presents various angles of a propeller 4. As depicted the propeller 4 depicted comprises two opposing blades 4a of standard shape. Any number of shaped blades are contemplated based on the power output of the motor 19 and the size or buoyancy of the decoy (1, 2, 3, 4, or more blades are possible). The decoy may comprise one propeller or it may comprise more than one propeller. The propeller may be connected directly to the motor shaft 19a. The propeller may be connected via a propeller nut 4b such as the one depicted in FIG. 20.

The propeller 4 is further designed and configured so that when the blades displace the surrounding water, the decoy is pulled down, toward the bottom of the waterbody. The buoyance of the buoy portion counteracts this force, which causes the decoy to bob in the water and produces chaotic or life-like movement. This motion mimics a feeding waterfowl and encourages other waterfowl to enter the area.

The propeller blade has a length, measured from the tip of one propeller blade through the center of the propeller. The propeller blade may be between 1-6 inches, 2-5 inches, and preferably between 1-3 inches. In a multi-blade propeller, the length of the propeller may comprise the distance between the two outermost tips of blades. For example, in embodiments wherein an even number of propeller blades are used, the length of the propeller (i.e., the diameter) may span from the outer most tip of one propeller blade to the outermost tip of an opposing propeller blade. In one or more embodiments, the propeller length may be less than 1, 2, 3, 4, 5, 6, 7, 8, 9, or 10 inches. In a preferred embodiment, the propeller blade may be less than 6 inches. In some embodiments, blades of varying sizes may be used.

As shown in FIG. 19(d), a propeller blade may have a blade angle. The propeller blade angle may be between 0 and 180 degrees, between 1 and 179 degrees, between 1 and 90 degrees, between 1 and 60 degrees, between 1 and 45 degrees, between 1 and 30 degrees, between 2 and 25 degrees, between 5 and 45 degrees, between 5 and 30 degrees, between 5 and 25 degrees, between 10 and 25 degrees, or between 10 and 20 degrees. In some embodiments, blades of varying blade angles may be used.

The propeller blades may also have a defined pitch. The pitch (measured in inches) may be between 0.1 and 10, between 0.5 and 8, between 0.5 and 6, between 0.5 and 4, between 1-6, between 1-5, between 1-4, between 1-3, between 2-6, between 2-5, between 2-4, between 2-3 or less than 10, less than 8, less than 6, less than 5, less than 4, less than 3, less than 2, less than 1.

FIGS. 10 and 11 depicts another embodiment of a decoy apparatus. This embodiment includes the protective guard 23. The protective guard 23 comprises a plurality of plate members 23a (as shown in FIG. 6). The protective guard 23 may be curved and connected to the connection arms 5a, 5b, 5c to form a ring-like barrier surrounding the propellor 4. The protective guard 23 acts as a safeguard to both the propellor and the user. It aims to protect the propellor 4 from objects in the water which may interfere with the propellor's operation and to protect the user from contacting the propellor 4 while the propellor is active. The plate members 23a may comprise a plate like structure with apertures or holes shaped therein to allow for fluid to pass through. Particularly, decoys are often used in shallower marshes; therefore, the apertures defined in protective guard plate member 23a are preferably shaped to reduce debris and weeds from engaging the propeller, causing damage or snag. In an alternate embodiment, the protective guard may comprise a plate structure with a plurality of openings that allows fluid to pass through it. Such openings may be shaped like a mesh. In one or more embodiments, the protective guard 23 may be connected to the arms in such a way as to be easily removed by the user. The protective guard 23 may encompass various materials and be configured in a manner such that it does not substantially interfere with the propulsion generated by the propellor. In an alternative embodiment, the guard may be formed from a single construction shaped around the decoy propeller. Likewise, the guard may comprise one or more solid plates, cages, horizontal and longitudinal members, and other structures to guard the propeller from interference by debris or injury to a user.

The battery 15 may be recharged through the depicted charging port. In other embodiments, the battery may be charged via solar panels or other charging means known in the art. The motor 19 preferably operates with a 12-volt power source, although alternate power sources are imagined, such as a 6-volt or 18-volt battery In a preferred embodiment, the motor 19 may be set to run automatically in timed intervals (for example, every 1, 3, or 5 minutes). In alternate embodiments, the motor may be controlled by a timer that causes the motor to operate in patterns of predetermined cycles of time on and off (intervals of a fraction of a second to several seconds). In other embodiments, however, the motor may be connected to an intermittent timer which may cause the motor to run in differing or sporadic periods. Ideally, in such an embodiment, the timer is set to have a maximum run time to reduce energy expenditure. In yet other embodiments, no timer may be used, and the motor may simply run until disengaged by the user. And in other embodiments, the motor may be controlled by remote or otherwise by user.

Turning to FIGS. 10 and 11, a different embodiment of a decoy device is provided for illustrative purposes. As shown, instead of buoy portion 3, this embodiment may comprise a module box 103 which may house various electronic components within its internal housing 112. Moreover, as shown, the motor housing 106 (and thus the motor which is not shown) may be positioned in between the propeller 104 and the module box 103. This configuration allows for a more compact unit with less drag. It also may allow for all electronic wiring to remain within the internal housing within the module box, allowing for more direct connection between the battery 115 and the motor 119 and removing the need for at least one external power port. In such an embodiment, the orientation, rotation or the blade angle of the propeller may be modified from the previously discussed embodiment wherein the motor is located beneath the propeller to provide the requisite driving force in the downward direction. In one such embodiment, the same propeller may be used but in an inverted configuration from the other design 1.

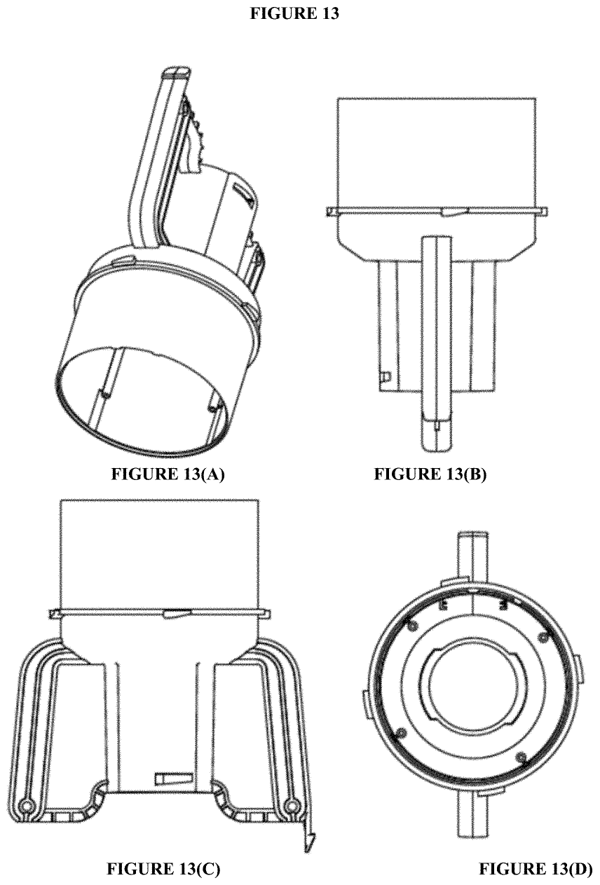

As shown in FIG. 13, the module box 103 may have a length and a diameter. The module box may directly or indirectly house multiple components, including one or more of the battery, a transmitter, circuitry, wiring, conduits, the motor, and other various components. The module box 103 may have a top portion 103a and a bottom portion 103b of substantially the same size or of varying sizes. As depicted, the top portion 103a is diametrically larger than the bottom portion 103b. This size difference may help to accommodate the components housed within the module box. The top portion 103a of the module box 103 defines an interior area which may be an interior housing 112 configured to house electronics. An illustrative example of interior housing 112 is shown in FIG. 12 showing mounting mechanisms 112(a), which is depicted as a channel into which a threaded screw or other fastener may be inserted, and a cavity 116 which is shaped to accommodate a battery. The interior housing may refer to the location within the module box wherein one or more components are stored, or it may refer to a specific structure within that location configured to house and accommodate specific components, such as the structure depicted in FIG. 12.

The top portion 103a and bottom portion 103b may be two separate components, or they may be one component. Preferably, the top and bottom portion may be contiguous and formed out of a single piece of molded plastic, although other suitable materials may be employed, e.g., plastic, metal, resin, wood, molded plastic, or other known materials. In one or more embodiments, the module box may comprise an opening such as on the top end of the top portion 103a to allow access into the module box. In such an embodiment, a lid may be used to selectively close the opening.

As depicted in FIG. 13, the diameter of top portion 103a tapers down into a cylindrical bottom portion 103b in which the motor is housed. As shown, the motor housing 106 is oriented vertically and the motor is mounted within the motor housing 106 such that the motor shaft extends outward and downward from the base of the motor housing. The motor housing 106 may comprise a mounting means 106a which allows the motor to be slide locked into place by configuring them with grooves 103c within the lower portion 103b, which are best depicted in top-down view of the module box in FIG. 13(d). Additional mounting means are well known in the art, including many which have been discussed in this application for alternative mounting functions. The motor shaft 119a has a length and two ends, a first end in connection with the motor and a second end opposing the first end to which the propeller is operationally coupled. At least a portion of the motor shaft 119a will extend out of the module box wherein it may be operationally connected either directly or indirectly to propellor 104. Preferably, the motor shaft is shaped to correspond with a nut or catch on the propeller.

The module box 103 may connect to the decoy portion 101. The module box may comprise attachment means to allow it to connect to the decoy. As depicted in FIG. 13, the module box 103 comprises slide members 122 on its side which may correspond with catches built into the decoy portion. Such components may be reversed such that one has the ridge and the other a catch, while each may employ both a ridge and catch that corresponds to the other. Likewise, other suitable means for connection are envisioned such as threaded connections, snap connections, slide connections, friction fit connections, slide-lock connections, hinge connections, and combinations thereof, to name a few.

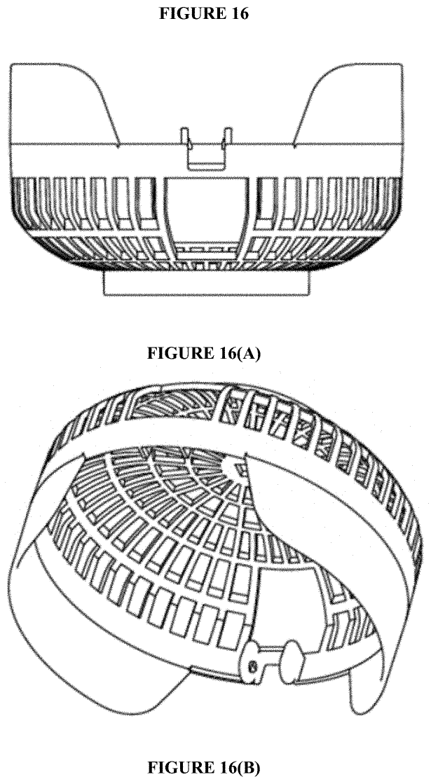

Additionally, the arms 105 may be attached to the module box. The arms may attach at either the top or bottom portion, or both the top and bottom portions. The connecting arms 105 may help stabilize the motor and motor housing and the propeller. This may reduce vibrational effect or noise from the operating motor. The arms also act as handles for the user. They may also provide support to which the guard 123 may be connected. The protective guard 123 comprises one or more longitudinal members 123b and latitudinal members 123c which are interconnected to form a cage or checkered pattern around the propeller 104. The protective guard 123 may be curved and connected to the connection arms 105a, 105b, 105c to form a ring-like barrier surrounding the propellor 104. Turning to FIG. 16, an alternative embodiment of a protective guard 123 may also comprise plate structures 123a to assist with protection and/or diversion of water flowing through the area where they are placed. As previously indicated, the longitudinal (or vertical) members 123b and latitudinal (or horizontal) members 123c may be interlaced to form a cage like structure with openings to allow water to pass into the chamber defined thereby. The openings may include smaller openings 123d or larger openings 123e configured to allow proper water flow through the system. The guard 123 may be plastic, metal, resin, wood, molded plastic, or other known materials. The guard may be rigid or semi-rigid. The guard base 124 may be closed, open, or at least partially open depending on the need to direct water through the base. The guard may be mounted in one or numerous means, including snap fits, cantilever snap fits, annular snap fits, u-shaped snap fits, torsion snap fits, grommets, sockets, couplings, screws, screw post fasteners, sex bolt fasteners, mating fasteners, and other fasteners, while in other embodiments, simpler hanging means such as hooks, catches, clips, or even a groove and catch may be used. As depicted, the guard may comprise a hinge 123f and a catch or clip 123g to secure it to the decoy. By using a hinge connection, the user may have easy access to the area surrounding the propeller in order to clear debris or for service of the unit.

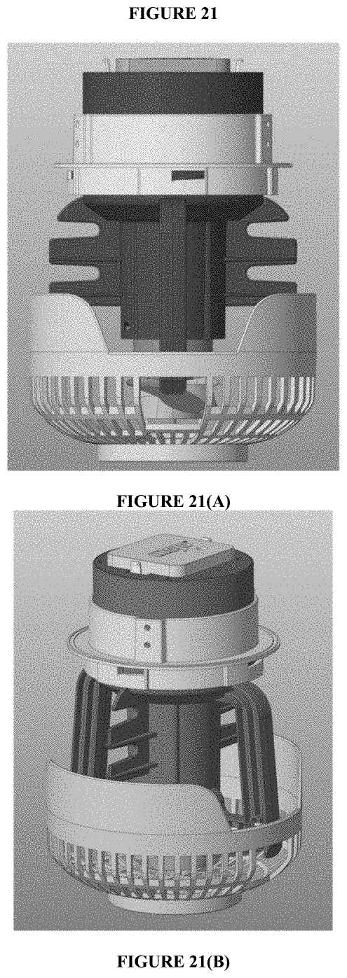

Turning to FIG. 21, an alternate embodiment of a module box 203 is presented with a different means for connecting the module box to the decoy portion. As shown, a slide-lock mechanism similar to the components depicted in FIG. 18(d) are used.

Additionally, this embodiment may comprise one or more fins 230 may be coupled to the exterior of the module box 203 to aid in the direction and flow of water passing through the area. The fins may extend outwards from the motor housing a distance. The distance may be confined to the area or pocket defined by the guard 223. The fins may comprise one or more inlets 231 which allow water to pass through them. The fins may be any suitable material, including plastic, metal, wood, resin, or molded plastic.

The decoy device may be configured to be self-righting. To aid in this property, the heavier internal components may be arranged such that the center of mass is central to the device. In one or more embodiments, the battery and motor are substantially in vertical alignment along the center axis of the device.

In operation, the motor 19 may be activated by an on/off switch either before or after the decoy portion 1 is secured to the buoy portion 2 based on the location of the switch. The decoy is then placed in a body of water. In some embodiments, the motor 19 is activated by a pre-set timer or remote control through, for example, a transmitter or a receiver wired to the control module in the inner housing 12 so that the motor 19 can be actuated after the decoy is placed in the water. In alternate embodiments, the decoy may be operationally configured to allow for a plug-in remote receiver to be in electronic communication with the control module.

Once the motor 19 is actuated (i.e. powered), the motor will rotate the motor shaft connected to the propeller causing the propeller to spin which displaces the surrounding water and produces a downward force on the decoy. This downward force is counteracted by the buoyance of the buoy portion 2, which may include additional buoyancy from foam fill in the outer buoy 3 and around the inner housing 12.

As the propeller draws the decoy down, at least a portion of the decoy portion 1 is pulled at least partially beneath the water. The counteracting buoyancy of the buoy continues to push the decoy upwards to float, causing a bobbing motion. Then the buoyancy force pushes the decoy portion 1 back up above the water line. In one or more embodiments, the propellor is actuated by the motor in varied cycles of time. This creates the random bobbing motion of a live waterfowl. The motion also creates ripples in the water and causes the decoy to bob off center, further simulating the chaotic motion of a live waterfowl. The self-righting buoy portion allows the decoy portion to sporadically bob while remaining above water.

In one or more embodiments, the protective guard 23 is inserted to prevent objects from interfering with the operation of the propellor 4 and to protect the user from contacting the propellor 4 while it is active. The composition and position of the protective guard 23 may vary in order to serve its protective purpose while not substantially hindering the decoy's operation.

In one or more embodiments, more than one of the decoy devices can be placed adjacent to one other or in combination with stationary or other mechanical decoys to simulate a flock of waterfowl that includes a simulated feeding waterfowl.

In battery powered embodiments, once the battery is depleted, the user removes the decoy from the water and charges the battery either through the device port or other charging means. In embodiments with removable batteries, the user may swap the depleted battery with a charged battery.

For the purpose of understanding the WATERFOWL DECOY MACHINE, references are made in the text to exemplary embodiments of a WATERFOWL DECOY MACHINE, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

What is claimed is:

1. A buoyant decoy comprising:
a. a decoy structure which is at least partially in the shape of at least a portion of a waterfowl; and
b. a housing comprising a motor, a battery, and a propeller, wherein the propellor and motor are configured such that when said motor is activated, the motor turns said propeller causing a downward thrust;
c. said decoy structure and said housing structure are operatively connected such that the downward thrust of the propellor causes at least a portion of the decoy to dip below the water line.

2. The decoy of claim 1 wherein said housing comprises an outer buoy structure and an inner housing.

3. The decoy of claim 2 wherein said inner housing comprises a plurality of cavities capable of accepting a battery and electronics.

4. The decoy of claim 1 wherein said housing further comprises a buoyant material filling.

5. The decoy of claim 3 wherein said inner housing is at least partially surrounded by a buoyant material.

6. The decoy of claim 1 wherein said housing is couplable to said decoy structure via watertight connection means.

7. The decoy of claim 1 wherein said downward thrust is counteracted and counteracts the downward motion of the decoy portion caused by the propeller so that the decoy bobs within the water while the propellor is engaged by the motor.

8. The decoy of claim 8 wherein the thrust created by the propeller is operatively configured to the buoyancy of the decoy element to allow for the bobbing motion when the motor is activated.

9. The decoy of claim 1 wherein the propeller has a pitch and comprises at least one blade with a blade angle and a length.

10. The decoy of claim 9 wherein the pitch is between 0.1 and 10 inches.

11. The decoy of claim 9 wherein the blade angle is between 2 and 35 degrees.

12. The decoy of claim 1 wherein the motor rotates between 1-250 rpm when activated.

13. The decoy of claim 1 wherein further comprising a protective guard at least partially around said propellor comprising intersecting longitudinal and latitudinal members.

14. The decoy of claim 13 wherein said protective guard is connected to said buoy structure via external connection arms to prevent said protective guard from impeding the motion of said propellor.

15. The decoy of claim 1 further comprising a receiver in communication with the motor and operationally configured to receive a signal to control the motor.

16. The decoy of claim 15 wherein the housing comprises a location for storing the receiver within said housing.

17. The decoy of claim 15 wherein the receiver receives a signal from a transponder selected from a group comprising a remote control, a Bluetooth device, or a cellular phone.

18. A buoyant decoy apparatus for use in a body of water comprising:
a. A housing structure shaped to mimic at least a portion of an animal;
b. A power supply;
c. A motor in connection with said power supply and a propeller having a pitch comprising at least one propeller blade, wherein the motor is capable of rotating the rotate said propeller between 1-250 rotations per minute;
d. A propeller guard operationally positioned at or near the propeller;
e. Wherein at least a portion of the decoy structure shaped to mimic an animal is positioned on the surface of the water at least when not acted upon by the propeller; wherein the motor and propeller are configured such that when the motor is powered, it rotates the propeller to create a downward force relative to surface of the water that propels the decoy deeper into the water; and wherein the buoyancy of the decoy causes the decoy to return towards the surface of the water when not counteracted by the propeller.

19. The buoyant decoy apparatus of claim 18 wherein the propeller has a blade angle between 10 and 60 degrees.

20. The buoyant decoy apparatus of claim 18 wherein the propeller has a pitch between 0.1 and 6 inches.
